(19) United States
(12) Patent Application Publication
(10) Pub. No.: US 2021/0094202 A1
(43) Pub. Date: Apr. 1, 2021

(54) Chainsaw System

(71) Applicant: Robert Bosch GmbH, Stuttgart (DE)

(72) Inventors: Jack Roden, Stowmarket, Suffolk (GB); Attila Nagy, Miskolc-Szirma (HU); Richard Wilkins, Ipswich (GB); Richard Poole, Bury St. Edmunds (GB); Csaba Szmutko, Miskolc (HU); John Lister, Bury St. Edmunds (GB)

(21) Appl. No.: 16/635,407

(22) PCT Filed: Sep. 5, 2018
(86) PCT No.: PCT/EP2018/073793

§ 371 Date: Jan. 30, 2020

(30) Foreign Application Priority Data
Sep. 25, 2017 (DE) 10 2017 216 870.6

(51) Int. Cl. B27B 17/02; B27B 17/14

(52) U.S. Cl. CPC B27B 17/02; B27B 17/14

(57) ABSTRACT

A chainsaw system includes a chainsaw and a saw blade module, which has a cutting chain and at least one guide unit for forming a guide for at least one part of the cutting chain. The chainsaw system further includes at least one coupling unit for coupling the saw blade module to the chainsaw and at least one release unit that has at least one fastening element and is provided in order to provide tool-free decoupling of the at least one saw blade module which is coupled by means of the coupling unit.

### PRIOR ART

There has already been proposed a chainsaw system, comprising a chainsaw and a saw blade module that comprises a cutting strand and at least one guide unit for guiding at least a part of the cutting strand, and comprising at least one coupling unit for coupling the saw blade module to the chainsaw.

### DISCLOSURE OF THE INVENTION

The invention is based on a chainsaw system, comprising a chainsaw and a saw blade module that comprises a cutting strand and at least one guide unit for guiding at least a part of the cutting strand, and comprising at least one coupling unit for coupling the saw blade module to the chainsaw.

It is proposed that the chainsaw have at least one release unit, which comprises at least one actuating element and which is designed for decoupling, without use of tools, the at least one saw blade module coupled by means of the coupling unit.

A “coupling unit” is to be understood here to mean, in particular, a unit designed to operatively connect the saw blade module to the portable chainsaw, by means of a form-fit and/or force-fit connection, for the purpose of performing work on a workpiece. In particular, when the coupling unit is connected to the chainsaw and the portable chainsaw is in an operating state, forces and/or torques can be transmitted from a transmission unit of the portable chainsaw to the saw blade module, in particular by means of a torque transmission element of the portable chainsaw, for the purpose of driving the cutting strand. Preferably, the portable chainsaw has a torque transmission element that, when the saw blade module is coupled to the portable chainsaw by means of the coupling unit, engages in the cutting strand for the purpose of driving the cutting strand. The torque transmission element is preferably arranged on the portable chainsaw, in particular arranged in a rotatably mounted manner. The torque transmission element may be realized, in particular, as a toothed shaft of a transmission unit of the portable chainsaw. The torque transmission element may also be realized as another component considered appropriate by persons skilled in the art. A “release element” in this context is to be understood to mean, in particular, a unit designed to release a form-fit and/or force-fit connection, between the saw blade module and the chainsaw, that is produced by means of the coupling unit and that couples the saw blade module to the chainsaw. In particular, the release unit is designed to release the form-fit and/or force-fit connection, between the saw blade module and the chainsaw, that is produced by means of the coupling unit and that couples the saw blade module to the chainsaw, for the purpose of separating the saw blade module from the chainsaw. An “actuating element” is to be understood to mean, in particular, an element designed to pick up an input quantity from an operator in the case of an operating control action, and in particular to be contacted directly by an operator, wherein contacting of the actuating element is sensed and/or an actuating force exerted upon the actuating element is sensed and/or is transferred mechanically for the purpose of actuating a unit, in particular a release mechanism. In particular, the actuating element is realized as an actuating lever and/or an actuating button.

The saw blade module is realized, in particular, as a closed system. The term “closed system” is intended here to define, in particular, a system comprising at least two components that, by means of combined action, when the system is removed from a system such as, for example, the portable chainsaw, that is of a higher order than the system, maintain a functionality and/or are captively connected to each other when in the removed state. Preferably, the at least two components of the closed system are connected to each other so as to be at least substantially inseparable by an operator. “At least substantially inseparable” is to be understood here to mean, in particular, a connection of at least two components that can be separated from each other only with the aid of parting tools such as, for example, a saw, in particular a mechanical saw, etc. and/or chemical parting means such as, for example, solvents, etc.

A “cutting strand” is to be understood here to mean, in particular, a unit designed to locally undo an atomic coherence of a workpiece on which work is to be performed, in particular by means of a mechanical parting-off and/or by means of a mechanical removal of material particles of the workpiece. Preferably, the cutting strand is designed to separate the workpiece into at least two parts that are physically separate from each other, and/or to part off and/or remove, at least partially, material particles of the workpiece, starting from a surface of the workpiece. Particularly preferably, in at least one operating state, the cutting strand is moved in a revolving manner, in particular along a circumferential direction of the guide unit of the saw blade module. Particularly preferably, the cutting strand is realized as a cutting chain. It is also conceivable, however, for the cutting strand to be of another design, considered appropriate by persons skilled in the art, such as, for example, designed as a cutting belt, on which a plurality of cutting-strand segments of the cutting strand are arranged.

A “guide unit” is to be understood here to mean, in particular, a unit designed to exert a constraining force upon the cutting strand, at least along a direction. perpendicular to the cutting direction of the cutting strand, in order to define a movement capability of the cutting strand along the cutting direction. Preferably, the guide unit has at least one guide element, in particular a guide slot, by which the cutting strand is guided, at least partially. Preferably, the cutting strand, as viewed in the cutting plane of the cutting strand, is guided by the guide unit along an entire circumference of the guide unit by means of the guide element, in particular the guide slot. A “cutting direction” is to he understood here to mean, in particular, a direction along which the cutting strand is moved, in at least one operating state, as a result of a driving force and/or a driving torque, in particular in the guide unit, for the purpose of generating a cutting gap and/or for the purpose of parting-off and/or removing material particles of a workpiece on which work is to be performed. “Designed” is to be understood to mean, in particular, specially programmed, configured and/or equipped. That an object is designed for a particular function, is to be understood to mean, in particular, that the object fulfils and/or executes this particular function in at least one application state and/or operating state.

The cutting strand can preferably be tensioned and/or pretensioned by means of the pretensioning unit, in particular when the cutting strand is arranged on the guide unit. The pretensioning unit is preferably designed to effect compensation of a play due to the production process and/or a tolerance due to the production process, in particular when the saw blade module is coupled to the chainsaw. The pretensioning unit is preferably designed to automatically effect compensation of a play due to the production process and/or a tolerance due to the production process, in particular when the saw blade module is coupled to the chainsaw. The pretensioning unit is particularly preferably designed to compensate an elongation of the cutting strand, in particular an elongation of the cutting strand caused by performing work on a workpiece. Particularly preferably, the pretensioning unit is designed preferably to automatically compensate the elongation of the cutting strand, in particular an elongation of the cutting strand caused by performing work on a workpiece. The elongation of the cutting strand, in particular an elongation of the cutting strand caused by performing work on a workpiece, can preferably be compensated automatically by means of the pretensioning unit. “An automatic compensation of play and/or tolerance” in this context is to be understood. to mean, in particular, a self-acting compensation of elongation, in particular that can be effected without intervention by an operator, and/or a self-acting compensation of a play and or tolerance of the cutting strand, when arranged on the guide unit, that is/are due to a production process, in particular that can be effected without intervention by an operator, by means of action of at least one tensioning force upon the cutting strand, in particular by an element realized separately from the cutting strand. Particularly preferably, the automatic tensioning and/or the automatic pretensioning of the cutting strand can be achieved without intervention by an operator of the portable chainsaw. Preferably, the pretensioning unit comprises at least one pretensioning element, in particular a spring element, arranged on a housing of the saw blade module. In particular, the pretensioning element is realized as a compression spring. The pretensioning element is preferably designed to exert a pretensioning force, in particular a pretensioning force directed away from the housing, upon the guide unit, on which the cutting strand is arranged. Preferably, the guide unit is mounted in a movable, in particular translationally movable, manner on the housing.

A design according to the invention makes it possible to provide a chainsaw system of the generic type that has advantageous features in respect of coupling a saw blade module to a portable chainsaw, and decoupling the saw blade module from the portable chainsaw. In particular, it can be made possible to release the saw blade module from the chainsaw in an advantageously simple manner, in particular without use of tools. This makes it possible, in particular, to achieve advantageously simple and/or rapid changing of the saw blade module.

It is additionally proposed that the chainsaw have at least one blocking unit that is designed at least to prevent the saw blade module, coupled by means of the coupling unit, from being decoupled by means of the release unit while the chainsaw is in operation. In particular, the blocking unit is designed to prevent functioning of the release unit during operation of the chainsaw, in particular while a motor of the chainsaw is running, at least in such a manner that undoing of the form-fit and/or force-fit connection, between the saw blade module and the chainsaw, that is produced by means of the coupling unit and that couples the saw blade module to the chainsaw, is largely prevented. In particular, the blocking unit is designed to block a release mechanism of the release mechanism, at least partially, in particular mechanically, and/or to operatively decouple it, at least partially, from the coupling unit. It is thereby possible, advantageously, to prevent release of the saw blade module while the chainsaw is in operation.

In a preferred design of the invention, it is proposed that the blocking unit have at least one decoupling blocking element that is designed to block an actuation of the actuating element of the release unit while the chainsaw is in operation. When the chainsaw is in an idle state, the decoupling blocking element is arranged, in particular, entirely outside of an actuating course of the actuating element of the release unit. In particular, during operation of the chainsaw, in particular while a motor of the chainsaw is running, the decoupling blocking element is arranged, at least partially, in a movement path of the actuating element. In particular, the decoupling blocking element is movably mounted and, upon the chainsaw being put into operation, can be moved, in particular can be slid and/or swiveled, at least partially, into an actuating course of the actuating element of the release unit. It is thereby possible, in an advantageously simple and reliable manner, to prevent actuation of the actuating element while the chainsaw is in operation.

Preferably, the blocking unit has at least one transmission element, which operatively couples an operating switch of the chainsaw to the decoupling blocking element and which is designed to transmit a movement of the operating switch to the decoupling blocking element. The transmission element is realized, in particular, as a transmission arm. In particular, at least one end of the transmission element is connected to an operating switch of the chainsaw. In particular, the end of the transmission element that is connected to the operating switch is designed to follow a movement of the operating switch, at least substantially. Preferably, the transmission element is designed to follow a movement of the operating switch at least substantially over its entire longitudinal extent. The decoupling blocking element is in particular arranged on and connected to a part of the transmission element that extends away from the operating switch. In particular, the transmission element is designed to transmit a movement of the operating switch to the decoupling blocking element in such a manner that the decoupling blocking element is in an actuating course of the actuating element of the release unit, at least partially, when the operating switch of the chainsaw is in an operating position. In addition, the transmission element is designed, in particular, to transmit a movement of the operating switch to the decoupling blocking element in such a manner that the decoupling blocking element is entirely outside of an actuating course of the actuating element of the release unit when. the operating switch of the chainsaw is in a neutral position. This makes it possible to effect advantageously simple and/or reliable blocking of the actuating element of the release unit.

It is additionally proposed that the chainsaw have at least one blocking unit that is designed at least to prevent the chainsaw from being put into operation while the release unit is in a decoupling mode. The blocking unit is designed, in particular, to prevent the chainsaw from being put into operation as long as the actuating element of the release unit is in a decoupling position. In particular, the blocking unit may be at least partially integral with the blocking unit, for the purpose of blocking the release unit while the chainsaw is in operation. Preferably, the chainsaw has at least one blocking unit that is both designed to block the release unit while the chainsaw is in operation and designed to prevent the chainsaw from being put into operation while the release unit is in a decoupling mode. In particular, the blocking unit is designed to prevent a motor of the chainsaw from being put into operation while the release unit is in a decoupling mode. In particular, the blocking unit may be designed to prevent the chainsaw from being put into operation, in particular being electronically and/or mechanically put into operation. Alternatively or additionally, the blocking unit may be designed to decouple a torque transmission element of the chainsaw from the motor of the chainsaw while the release unit is in a decoupling mode, such that there can be no transmission of torque to the cutting strand of the saw blade module. It is thereby possible to achieve a high degree of operating safety of the chainsaw system, in particular when a saw blade module is being decoupled from the chainsaw. In particular, it is possible, in an advantageously reliable manner, to prevent the chainsaw from being put into operation when a saw blade module is being decoupled.

It is also proposed that the blocking unit have at. least one operation blocking element that is designed to block, in particular mechanically, an actuation of an operating switch of the chainsaw while the release unit is in a decoupling mode. The operation blocking element is designed, in particular, to mechanically block, directly or indirectly, at least to a large extent, an actuation course of the operating switch while the release unit is in a decoupling mode. In particular, the operation blocking element is designed to directly or indirectly block the operating switch of the chainsaw, when in a neutral position, while the release unit is in a decoupling mode. In particular, the operation blocking element is connected to the actuating element of the release unit, or is at least partially integral with the actuating element of the release unit. “Integral” is to be understood to mean, in particular, connected in a materially bonded manner such as, for example, by a welding process and/or an adhesive process, etc., and particularly advantageously by being molded-on, for example being produced from a casting and/or by produced in a single or multi-component injection process. In particular, the operation blocking element is designed to follow a movement of the actuating element of the release unit, at least substantially. In particular, the operation blocking element is designed to act upon the decoupling blocking element and block a movement of the decoupling blocking element when the actuating element of the release unit is in a decoupling position. The decoupling blocking element is in particular arranged on and connected to a part of the transmission element that extends away from the operating switch, with the result that a movement of the transmission element is likewise blocked by the blocking of the decoupling blocking element. The transmission element is connected to the operating switch of the chainsaw, with the result that the movement of the operating switch is also blocked. This makes it possible to effect advantageously simple and/or reliable blocking of the operating switch of the chainsaw. It is thereby possible, in an advantageously simple and reliable manner, to prevent the chainsaw from being put into operation while the release unit is in a decoupling mode.

Furthermore, it is proposed that the chainsaw have at least on recoil safeguard element that is designed to prevent, at least to a large extent, a manual actuation of the actuating element of the release unit while the chainsaw is in operation. The recoil safeguard element is realized, in particular, as a recoil lever. In particular, the recoil safeguard element is designed, in the case of a recoil of the chainsaw system resulting from an actuation by an operator of the chainsaw system, to be brought from an operating position into a brake position. In particular, the recoil safeguard element is designed, in the brake position, to cause the chainsaw, in particular the motor of the chainsaw, to brake. In particular, the recoil safeguard element is designed, in an operating position, to mechanically cover the release unit, at least partially, and preferably at least to a large extent. In particular, the recoil safeguard element is designed, in an operating position, to mechanically cover the actuating element by at least 70%, preferably by at least 80%, more preferably by at least 90% and, particular preferably, completely. Manual actuation of the actuating element of the release unit while the chainsaw is in operation can thus advantageously be prevented, at least to a large extent.

In a preferred design of the invention, it is proposed that the coupling unit have at least one locking unit, and at least one locking element that is designed to latch within the locking unit. In particular, the locking element may be arranged on the saw blade module, and the locking unit on the chainsaw. Alternatively, the locking element may be arranged on the chainsaw, and the locking unit on the saw blade module. The locking unit may be realized, in particular, in the form of a pin or bolt. The locking unit has, in particular, a receiving recess that is designed to receive the locking element, at least partially. In particular, the locking element has at least one latching means that is designed to latch, preferably automatically, within the receiving recess when inserted in the receiver of the locking unit. The latching means may be realized, in particular, as a material recess, a material projection, an in particular spring-preloaded expansion head and/or an in particular spring preloaded tensioning head. In particular, the latching means is designed, upon insertion, to latch, preferably automatically, with a corresponding locking element of the locking unit, and/or within the receiving recess, in particular as a result of expanding, at least partially. In particular, the release unit is designed to release the latching connection produced by means of the locking element. In particular, the latching connection produced by means of the locking element can be undone by an actuation of the actuating element of the release unit. An advantageously simple and/or secure mechanical coupling, between the saw blade module and the chainsaw, can thereby be achieved.

It is additionally proposed that the locking element have at least one locking head, and the locking unit have at least one locking element that is designed to engage behind the locking head, at least in a locking state. In particular, the locking element is realized as a bolt, having an in particular circumferential groove. The locking head is formed, in particular, by the circumferential groove on the bolt. The locking element of the locking unit is designed, upon insertion of the locking element into the locking unit, to engage in the groove. In particular, the locking element may be spring-preloaded, such that it latches automatically into the groove and is held in the locking position by a spring force. The locking unit is preferably designed, at least when the saw blade module is arranged on the chainsaw, to support and/or transmit transverse forces, in particular along a transverse forces that is at least substantially parallel to a drive axis of a torque transmission element of the chainsaw. Advantageously secure fastening of the saw blade module to the chainsaw can thus be effected.

Preferably, the locking unit may have at least one magnet element that is designed, in at least one operating state, to exert a holding force upon the locking element.

In. particular, the magnet element is designed, at least upon an actuation of the actuating element of the release unit, to exert a magnetic holding force upon the locking element. This makes it possible to achieve advantageously safe release of the saw blade module from the chainsaw.

It is additionally proposed that the chainsaw have at least one receiving recess that is designed to receive the saw blade module, at least partially, in a mounted state. In particular, the receiving recess is formed, at least partially, from a housing of the chainsaw. The receiving recess has at least one inner contour that corresponds, at least substantially, to an outer contour of a housing of the saw blade module. In particular, the receiving recess of the chainsaw is designed to receive at least the housing of the saw blade module.

Preferably, the coupling unit has at least one positioning bolt that is designed to align and/or orient the saw blade module relative to the chainsaw. Alternatively or additionally, the receiving recess of the chainsaw is designed to align and/or orient the saw blade module relative to the chainsaw. The positioning bolt is at least substantially parallel to the locking element. “Substantially parallel” is to be understood here to mean, in particular, an alignment of a direction relative to a reference direction, in particular in one plane, the direction deviating from the reference direction by, in particular, less than 8°, advantageously less than 5°, and particularly advantageously less than 2°. Advantageously simple positioning of the saw blade on the chainsaw can thus be achieved. The positioning bolt is preferably designed, in at least one state in which the saw blade module is arranged on the chainsaw, to support forces and/or moments acting upon the chainsaw via the saw blade module, in particular forces and/or moments in a plane extending at least substantially perpendicularly in relation to a drive axis of the torque transmission. element of the chainsaw. Preferably, the positioning bolt is realized as a counter-bearing for supporting drive moment and/or supporting drive force. Preferably, the saw blade module can be arranged with little play, at least substantially, on the chainsaw by means of the positioning bolt.

Additionally proposed is a saw blade module for use in a chainsaw system according to the invention, having at least one coupling unit for coupling the saw blade module to a chainsaw, a cutting strand, and at least one guide unit for guiding at least a part of the cutting strand.

Also proposed is a chainsaw for use in a chainsaw system according to the invention. In particular, the chainsaw has at least one motor, in particular an electric or internal combustion motor, which is designed to drive a cutting strand a saw blade module coupled to the chainsaw.

The chainsaw system according to the invention, the saw blade module according to the invention and/or the power tool system according to the invention are/is not intended in this case to be limited to the application and embodiment described above. In particular, the chainsaw system according to the invention, the saw blade module according to the invention and/or the power tool system according to the invention may have individual elements, components and units that differ in number from a number stated herein, in order to fulfill a functionality described herein. Moreover, in the case of the value ranges specified in this disclosure, values lying within the stated limits are also to be deemed as disclosed and applicable in any manner.

### DRAWING

Further advantages are given by the following description of the drawing. The drawing shows two exemplary embodiments of the invention. The drawing, the description and the claims contain numerous features in combination. Persons skilled in the art will also expediently consider the features individually and combine them to create appropriate further combinations.

There are shown:

FIG. 1 a chainsaw system, having a chainsaw and a saw blade module in a coupled state, in a schematic representation,

FIG. 2 a chainsaw system, in an uncoupled state, in a schematic representation,

FIG. 3a an exploded representation of a locking unit and a release unit of the chainsaw system, in a schematic representation,

FIG. 3b an explode representation of the saw blade module, in a schematic representation,

FIG. 4 a blocking unit of the chainsaw system, in an initial state, in a schematic representation,

FIG. 5 the blocking unit or the chainsaw system during operation of the chainsaw, in a schematic representation,

FIG. 6 a blocking unit of the chainsaw system in a decoupling state for releasing the saw blade module, in a schematic representation,

FIG. 7 a recoil safeguard element of the chainsaw, which partially covers an actuating element of the release unit, in a schematic representation,

FIG. 8 an alternative recoil safeguard element of the chainsaw, which partially covers an actuating element of the release unit, in a schematic representation,

FIG. 9 a further alternative recoil safeguard element of the chainsaw, which partially covers an actuating element of the release unit, in a schematic representation, and

FIG. 10 an alternative chainsaw system, having a chainsaw and a saw blade module in a uncoupled state, in a schematic representation.

### DESCRIPTION OF THE EXEMPLARY EMBODIMENTS

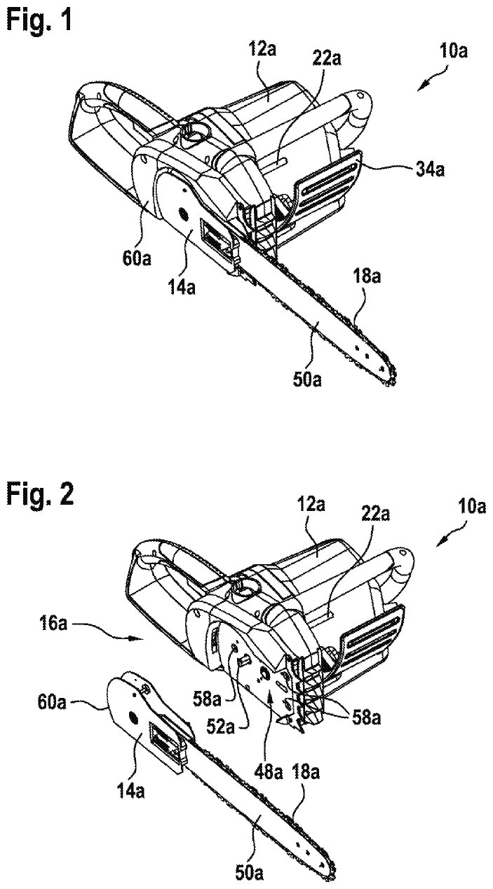

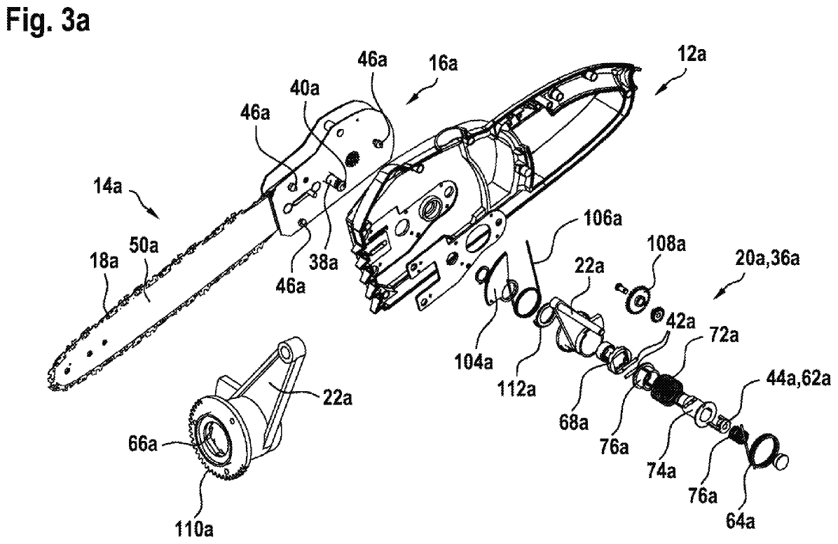

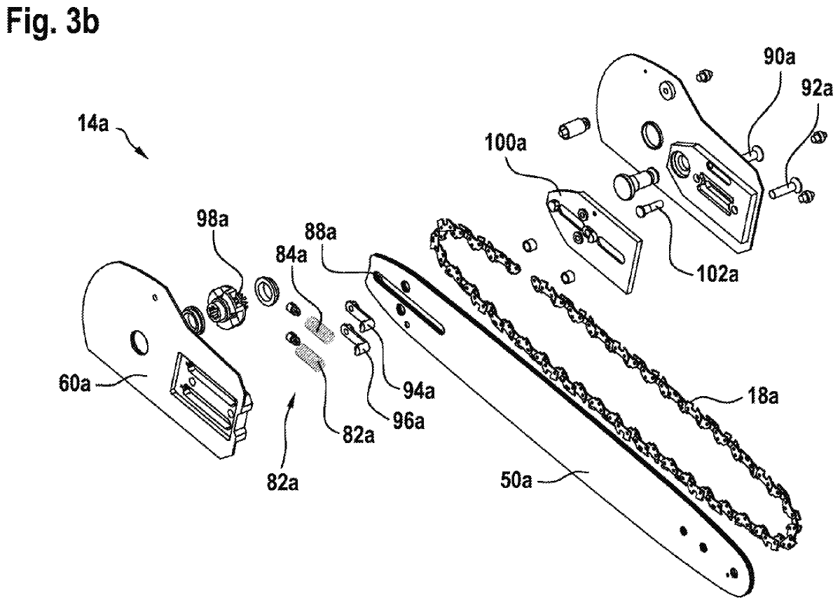

FIG. 1 shows a perspective representation of a chainsaw system 10a, having a chainsaw 12a and a saw blade module 14a, in a mounted state. FIG. 2 shows a perspective representation of a chainsaw system 10a in an unmounted state, in which the saw blade module 14a is decoupled from the chainsaw 12a. The saw blade module 14a has a cutting strand 18a, and at least one guide unit 50a for guiding at least a part of the cutting strand 18a. The chainsaw system 10a also has a coupling unit 16a for coupling the saw blade module 14a to the chainsaw 12a. The coupling unit 16a is designed to connect the saw blade module 14a to the portable chainsaw 12a, by means of a form-fit and/or force-fit connection, for the purpose of performing work on a workpiece. In particular, when the coupling unit 16a is connected to the chainsaw 12a and the chainsaw 12a is in an operating state, forces and/or torques are transmitted from a transmission unit of the chainsaw 12a to the saw blade module 14a, for the purpose of driving the cutting strand 18a. Preferably, the chainsaw 12a has a torque transmission element 52a which, when the saw blade module 14a is coupled to the chainsaw 12a by means of the coupling unit 16a, engages in the cutting strand 18a, or in a pinion 98a of the saw blade module 14a that is rotatably mounted in a housing 60a of the saw blade module 14a (see FIG. 3b) for the purpose of driving the cutting strand 18a. The torque transmission element 52a is arranged in a rotatably mounted manner on the chainsaw 12a. The torque transmission element 52a may be realized, in particular, as a toothed shaft 54a of a transmission unit of the portable chainsaw 12a. The chainsaw 12a has at least one receiving recess 48a that is designed to receive the saw blade module 14a, at least partially, in a mounted state. The receiving recess 48a has at least one inner contour that corresponds, at least substantially, to an outer contour of the housing 60a of the saw blade module 14a.

The coupling unit 16a has a locking unit 36a, and at least one locking element 38a that is designed to latch within the locking unit 36a. The chainsaw 12a also has at least one release unit 20a, having at least one actuating element 22a that is designed to decouple the at least one saw blade module 14a, coupled by means of the coupling unit 16a, without use of tools. The locking unit 36a and the release unit 20a are realized, at least partially, as a single piece. FIG. 3a shows the locking unit 36a and the release unit 20a in an exploded representation. The locking element 38a has at least one locking head 40a, and the locking unit 36a has at least one locking means 42a that is designed to engage behind the locking head 40a, at least in a locking state. Here, for example, the coupling unit 16a has two locking elements 38a, realized as locking pins. Upon the locking element 38a being inserted into the locking unit 36a, a fork element 62a is pushed out of the locking position by the locking element 38a. The actuating element 22a of the release unit 20a is rotated into a locking position by a torsion spring 64a. In an interior, the actuating element 22a has a cam track 66a that is rotated jointly with the actuating element 22a. A lever element 68a and a release ring 70a are displaced by a compression spring 72, as a result of which the locking means 42a are released and go into a locking position. The coupling unit 16a also has at least one positioning bolt 46a that is designed to align and/or orient the saw blade module 14a relative to the chainsaw 12a. For example, the coupling unit 16a has three positioning bolts 46a, while the chainsaw 12a has a corresponding number of receivers 58a for the positioning bolts 46a. Upon the saw blade module 14a being mounted on the chainsaw 12a, the positioning bolts 46a engage in the receivers 58a for the purpose of positioning the saw blade module 14a relative to the chainsaw 12a.

The release unit 20a is designed to undo the form-fit and/or force-fit connection, between. the saw blade module 14a and the chainsaw 12a, that is produced. by means of the coupling unit 16a and that couples the saw blade module 14a to the chainsaw 12a. In particular, the release unit 20a is designed to undo the form-fit and/or force-fit connection, between the saw blade module 14a and the chainsaw 12a, that is produced by means of the coupling unit 16a and that couples the saw blade module 14a to the chainsaw 12a, for the purpose of separating the saw blade module 14a from the chainsaw 12a. For the purpose of decoupling, the actuating element 22a of the release unit 20a is actuated in a rotary movement. The cam track 66a creates a pull on the lever element 68a. The locking means 42a are moved out of the locking position by a cam mechanism element 74a that is pressed in the direction of the actuating element 22a by means of a spring element 76a. The locking unit 36a has at least one magnet element 44a that is designed, in at least one operating state, to exert a holding force upon due locking element 38a. Preferably, the magnet element 44a is designed, upon an actuation of the actuating element 22a of the release unit 20a, to exert a magnetic holding force upon the locking element 38a. When the saw blade module 14a is being decoupled from the chainsaw 12a, this magnetic holding force must be overcome by an operator of the chainsaw system 10a. It is thereby possible to prevent, in particular, the locking element 38a from inadvertently slipping out, and thus to prevent inadvertent release of the saw blade module 14a from the chainsaw 12a upon actuation of the actuating element 22a of the release unit 20a.

The saw blade module 14a preferably comprises at least one pretensioning unit 82a for automatically compensating a play due to the production process and/or a tolerance of the cutting strand 18a due to the production process (see FIG. 3b). Preferably, the pretensioning unit 82a comprises at least one pretensioning element 84a, 86a, in particular a spring element, arranged on the housing 60a of the saw blade module 14a. In the design represented in FIG. 3b, the pretensioning unit 82a has at least two pretensioning elements 84a, 86a, which are realized as spring elements, in particular as compression springs.

It is also conceivable, however, for the pretensioning unit 82a to comprise a number of pretensioning elements 84a, 86a′ other than two. The pretensioning element/s 84a, 86a is/are preferably designed to exert a pretensioning force, in particular a pretensioning force directed away from the housing, upon the guide unit 50a, on which the cutting strand 18a is arranged. Preferably, the guide unit. 50a is mounted in a movable, in particular translationally movable, manner on the housing 60a. The guide unit 50a preferably has at least one movement guide element 88a, in particular a guide slot. The movement guide element 88a preferably acts in combination with at least one, in particular at least two, counter-guide element/s 90a, 92a of the saw blade module 14a. The counter-guide element/s 90a, 92a is/are preferably realized as a guide bolt or as a guide sleeve/s. The counter-guide element/s 90a, 92a preferably engage, at least partially, in the movement guide element 88a, in particular in the movement guide element 88a realized as a guide slot, or extend through the movement guide element 88a. A maximum movement distance of the guide unit 50a relative to the housing 60a can preferably he limited by means a combined action of the movement guide element 88a and the counter-guide element/s 90a, 92a. One end of the pretensioning element/s 84a, 86a is preferably supported on the housing 60a, in particular on a wall of the housing 60a that delimits a recess of the housing 60a. Another end of the counter-guide element/s 90a, 92a is/are supported on the guide unit 50a and/or on at least one support element 94a, 96a arranged on the guide unit 50a or on a slide element 100a of the saw blade module 14a. The slide element 100a is preferably fixed to the guide unit 50a. The slide element 100a is preferably mounted in the housing 60a so as to be movable, in particular translationally movable, together with the guide unit 50a, relative to the housing 60a. A tensioning bolt 102a of the pretensioning unit 82a is fixed to the guide unit 50a and/or to the slide element 100a. The tensioning bolt 102a extends out of the housing 60a, in particular along a direction that is at least substantially perpendicular to a cutting plane of the cutting strand 18a.

When the saw blade module 14a is arranged on the chainsaw 12a, the tensioning bolt 102a extends into the chainsaw 12a. When the saw blade module 14a is arranged on the chainsaw 12a, the tensioning bolt 102a can operatively connected to an eccentric element 104a of the release unit 20a and/or the locking unit 36a. In at least one state of the release unit 20a and/or the locking unit 36a, a force can. be applied the eccentric element 104a by means of a tensioning element 106a of the release unit 20a and/or the locking unit 36a. The tensioning element 106a is preferably realized as a torsion spring. The tensioning element 106a applies to the eccentric element a spring force that acts in a direction away from the tensioning bolt 102a. As a result of a movement of the actuating element 22a, a movement transmission element 108a, in particular a toothed wheel, of the release unit 20a and/or of the locking unit 36a can be moved. The actuating element 22a preferably has an external toothing 110a, which is designed to engage in the movement transmission element 108a. The movement transmission element 108a is preferably designed to move the eccentric element 104a in dependence on a movement of the actuating element 22a, in particular at least in the direction of the tensioning bolt 102a. Preferably, the movement transmission element 108a is designed to move the eccentric element 104a, in particular at least in the direction of the tensioning bolt 102a, via a blocking element 112a of the release unit 20a and/or of the locking unit 36a. The blocking element 112a is preferably designed, in at least one state, to block a moment of the eccentric element 104a by the tensioning element 106a. The blocking element 112a preferably comprises a blocking offset, which is designed, at least in one state, to bear against a blocking face of the eccentric element 104a. The blocking element 112a preferably has at least one circular toothing segment, which is designed to act in combination with the movement transmission element 108a.

Arranging of the saw blade module 14a on the chainsaw 12a causes the tensioning bolt 102a to be inserted into the chainsaw 12a. As a result of a movement of the actuating element 22a, the blocking element 112a can be moved into a blocking position, via the movement transmission element 108a. The blocking element 112a comes to bear against. the eccentric element 104a and moves it, contrary to the spring force of the tensioning element 106a, in the direction of the tensioning bolt 102a. Owing to the toothing of the blocking element 112a, the movement transmission element 108a and the actuating element 22a, a movement of the eccentric element 104a is ensured. The eccentric element 104a can move the tensioning bolt 102a, and/or hold it in a position, relative to the housing 60a for the purpose of tensioning and/or holding a tensioning of the cutting strand 18a. As a result of the actuating element 22a being moved into a release position, in which the saw blade module 14a can be removed from the chainsaw 12a, the blocking element 112a can be moved away from the eccentric element 104a. The eccentric element 104a can be moved into an initial position by the spring force of the tensioning element 106a. The tensioning bolt 102a can be moved independently of the eccentric element 104a. Pretensioning of the cutting strand 18a is effected by the pretensioning unit 82a.

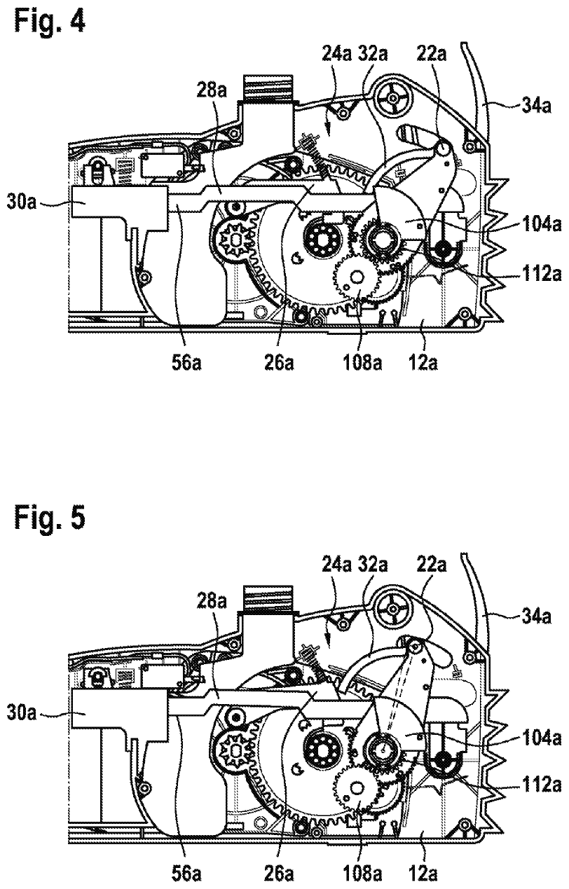

The chainsaw 12a has at least one blocking unit 24a that is designed to prevent the saw blade module 14a, coupled by means of the coupling unit 16a, from being decoupled by means of the release unit 20a while the chainsaw 12a is in operation. The blocking unit 24a is represented in FIGS. 4 to 6, in differing operating states. FIG. 4 shows the blocking unit 24a in an initial operating state. In particular, the blocking unit 24a is designed to prevent functioning of the release unit 20a during operation of the chainsaw 12a, in particular while a motor is running, in such a manner that undoing of the form-fit and/or force-fit connection, between the saw blade module 14a and the chainsaw 12a, that is produced by means of the coupling unit 16a, is prevented. The blocking unit 24a has at least one decoupling blocking element. 26a that is designed to block an actuation of the actuating element 22a of the release unit 20a while the chainsaw 12a is in operation (see FIG. 5). When the chainsaw 12a is in an idle state, the decoupling blocking element 26a is arranged entirely outside of an actuating course of the actuating element 22a of the release unit 20a. During operation of the chainsaw 12a, in particular while a motor of the chainsaw 12a is running, the decoupling blocking element 26a is arranged, at least partially, in a movement path of the actuating element 22a of the release unit 20a. The decoupling blocking element 26a is movably mounted and, upon the chainsaw 12a being put into operation, can be moved, in particular can be slid and/or swiveled, at least partially, into an actuating course of the actuating element 22a of the release unit 20a. The blocking unit 24a has at least one transmission element 28a, which operatively couples an operating switch 30a of the chainsaw 12a to the decoupling blocking element 26a and which is designed to transmit a movement of the operating switch 30a to the decoupling blocking element 26a. The transmission element 28a is realized as a transmission arm. One end 56a of the transmission element 28a is connected to the operating switch 30a of the chainsaw 12a. The end 56a of the transmission element 28a that is connected to the operating switch 30a is designed to follow a movement of the operating switch 30a, at least substantially. Preferably, the transmission element 28a is designed to follow a movement of the operating switch 30a at least substantially over its entire longitudinal extent. The decoupling blocking element 26a is arranged on the transmission element 28a, and connected to it. The transmission element 28a is designed to transmit a movement of the operating switch 30a to the decoupling blocking element 26a in such a manner that the decoupling blocking element 26a is in an actuating course of the actuating element 22a of the release unit 20a, at least partially, when the operating switch 30a of the chainsaw 12a is in an operating position. An actuation of the actuating element 22a of the release unit 20a is thereby blocked. The transmission element 2$a is also designed to transmit a movement of the operating switch 30a to the decoupling blocking element 26a in such a manner that the decoupling blocking element 26a is entirely outside of actuating course of the actuating element 22a of the release unit 20a, when the operating switch. 30a of the chainsaw 12a is in an idle position. An actuation of the actuating element 22a of the release unit 20a is possible in this state.

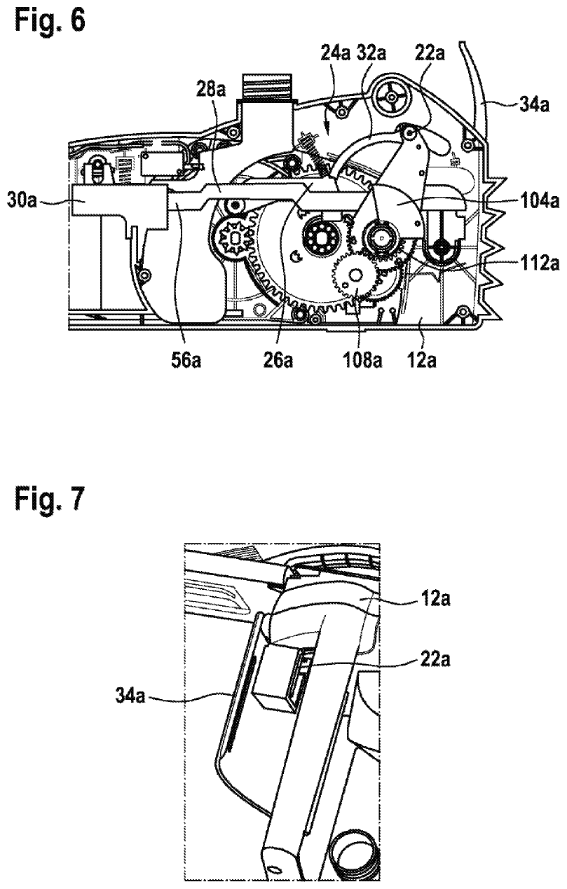

The blocking unit 24a is also designed to prevent the chainsaw 12a from being put into operation while the release unit 20a is in a decoupling mode. The blocking unit 24a is designed, in particular, to prevent the chainsaw 12a from being put into operation as long as the actuating element 22a of the release unit 20a is in a decoupling position. In particular, the blocking unit 24a is designed to prevent a motor of the chainsaw 12a from being put into operation while the release unit 20a is in a decoupling mode. The blocking unit 24a has at least one operation blocking element 32a that is designed to block an actuation of the operating switch 30a of the of the chainsaw 12a while the release unit 20a is in a decoupling mode (see FIG. 6). The operation blocking element 32a is designed to mechanically block an actuation course of the operating switch 30a while the release unit 20a is in a decoupling mode. In particular, the operation blocking element 32a is designed to block the operating switch 30a of the chainsaw 12a in a release position while the release unit 20a is in a decoupling mode. The operation blocking element 32a is connected to the actuating element 22a of the release unit 20a, or is at least partially integral with the actuating element. 22a of the release unit 20a. The operation blocking element 32a is designed to follow a movement of the actuating element 22 of the release unit 20a. The operation blocking element 32a is designed to act upon the decoupling blocking element 26a and block a movement of the decoupling blocking element 26a when the actuating element 22a of the release unit 20a is in a decoupling position. The decoupling blocking element 26a is arranged on the transmission element 28a, and connected to it, with the result that a movement of the transmission element 28a is likewise blocked by the blocking of the decoupling blocking element 26a. The transmission element 28a is connected to the operating switch 30a of the chainsaw 12a, with the result that the movement of the operating switch 30a is also blocked.

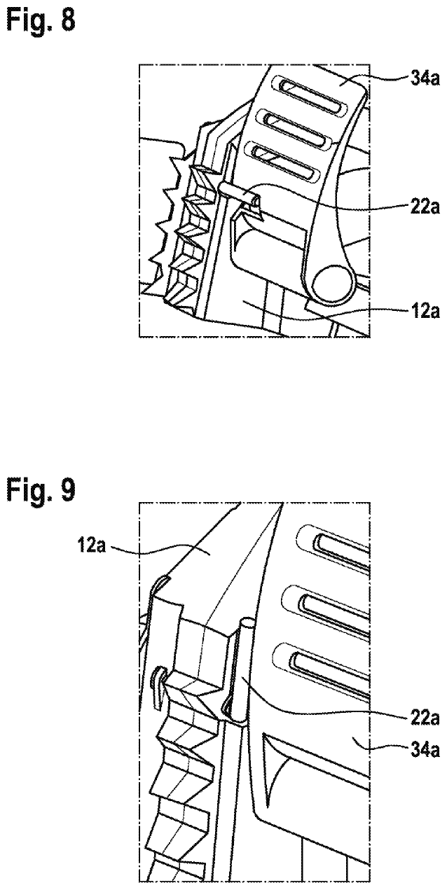

The chainsaw 12a also has at least one recoil safeguard element 34a. The recoil safeguard element 34a may be designed to prevent, at least to a large extent, a manual actuation of the actuating element 22a of the release unit 20a while the chainsaw 12a is in operation. The recoil safeguard element 34a is realized as a recoil lever. The recoil safeguard element 34a is designed, in the case of a recoil of the chainsaw system 10a resulting from an actuation by an operator of the chainsaw system 10a, to be brought from an operating position into a brake position. In particular, the recoil safeguard element 34a may be designed, in the brake position, to cause the chainsaw 12a, in particular the motor of the chainsaw 12a, to brake. The recoil safeguard element 34a is designed, in the operating position, to mechanically cover the actuating element 22a of the release unit 20a, at least partially, and preferably at least to a large extent. FIGS. 7 to 9 show differing embodiments of a recoil safeguard element 34a that covers the actuating element 22a of the release unit 20a, at least partially, and preferably at least to a large extent.

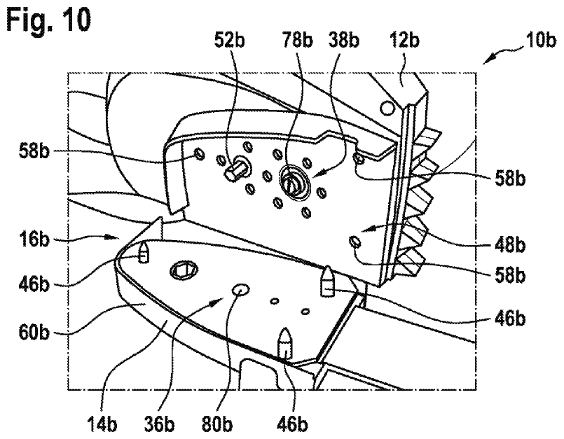

FIG. 10 shows a further exemplary embodiment of the invention. The following descriptions and the drawings are limited substantially to the differences between the exemplary embodiments and, in principle, reference may be made to the drawings and/or the description of the other exemplary embodiments, in particular to FIGS. 1 to 9, in respect of components having the same designation, in particular i respect of components having the same reference numerals. To distinguish the exemplary embodiments, the letter a has been appended to the references of the exemplary embodiment in FIGS. 1 to 9. In the exemplary embodiments of FIG. 10, the letter a has been replaced by the letter b.

FIG. 10 shows an alternative chainsaw system 10b in an unmounted state, in which the saw blade module 14b has been decoupled from the chainsaw 12b. The chainsaw system 10b has a coupling unit 16b for coupling the saw blade module 14b to the chainsaw 12b. The coupling unit 16b is designed to connect the saw blade module 14b to the portable chainsaw 12b, by means of a form-fit and/or force-fit connection, for the purpose of performing work on a workpiece. In particular, when the coupling unit 16b is connected to the chainsaw 12b and the chainsaw 12b is in an operating state, forces and/or torques are transmitted from a transmission unit of the chainsaw 12b to the saw blade module 14b, for the purpose of driving the cutting strand 18b. Preferably, the chainsaw 12b has torque transmission element 52b which, when the saw blade module 14b is coupled to the chainsaw 12b by means of the coupling unit 16b, engages in the cutting strand 18b for the purpose of driving the cutting strand 18b. The torque transmission element 52b is arranged in a rotatably mounted manner on the chainsaw 12b. The torque transmission element 52b may be realized, in particular, as a toothed shaft 54b of a transmission unit of the chainsaw 12b. The chainsaw 12b has at least one receiving recess 48b that is designed to receive the saw blade module 14b, at least partially, in a mounted state. The receiving recess 48b has at least one inner contour that corresponds, at least substantially, to an outer contour of a housing 60b of the saw blade module 14b.

The coupling unit 16b has a locking unit 36b, and at least one locking element 38b that is designed to latch within the locking unit 36b. The locking element 38b is arranged on the chainsaw 12b. The locking unit 36b is arranged on the saw blade module 14b. The locking element 38b has a latching and/or expansion head 78b. Upon the saw blade module 14b being coupled to the chainsaw 12b, the latching and/or expansion head 78b latches in a recess 80b of the locking unit 36b. The coupling unit 16b also has at least one positioning bolt 46b that is designed to align and/or orient the saw blade module 14b relative to the chainsaw 12b. For example, the coupling unit 16b has three positioning bolts 46b, while the chainsaw 12b has a corresponding number of receivers 58b for the positioning bolts 46b. Upon the saw blade module 14b being mounted on the chainsaw 12b, the positioning bolts 46b engage in the receivers 58b for the purpose of positioning saw blade module 14b relative to the chainsaw 12b.

1. A chainsaw system, comprising:
a chainsaw having at least one release unit;
a saw blade module comprising a cutting strand and at least one guide unit designed to guide at least a part of the cutting strand; and
at least one coupling unit designed to couple the saw blade module to the chainsaw, wherein
the chainsaw at least one release unit includes at least one actuating element, the at least one release unit designed for decoupling, without use of tools, the at least one saw blade module that is coupled by the coupling unit.

2. The chainsaw system as claimed in claim 1, wherein the chainsaw has at least one blocking unit that is designed at least to prevent the saw blade module, coupled by means of the coupling unit, from being decoupled by the release unit while the chainsaw is in operation.

3. The chainsaw system as claimed in claim 2, wherein the blocking unit has at least one decoupling blocking element that is designed to block an actuation of the actuating element of the release unit while the chainsaw is in operation.

4. The chainsaw system as claimed in claim 3, wherein the blocking unit has at least one transmission element operatively coupling an operating switch of the chainsaw to the decoupling blocking element, the at least one transmission element being designed to transmit a movement of the operating switch to the decoupling blocking element.

5. The chainsaw system as claimed in claim 1, wherein the chainsaw has at least one blocking unit designed at least to prevent the chainsaw from being put into operation while the release unit is in a decoupling mode.

6. The chainsaw system as claimed in claim 5, wherein the blocking unit has at least one operation blocking element that is designed to block an actuation of an operating switch of the chainsaw while the release unit is in a decoupling mode.

7. The chainsaw system as claimed in claim 1, wherein the chainsaw has at least one recoil safeguard element designed to prevent, at least to a large extent, a manual actuation of the actuating element of the release unit while the chainsaw is in operation.

8. The chainsaw system as claimed in claim 1, wherein the coupling unit has at least one locking unit and at least one locking element designed to latch within the locking unit.

9. The chainsaw system as claimed in claim 8, wherein the locking element has at least one locking head, and the locking unit has at least one locking element designed to engage behind the at least one locking head, at least in a locking state.

10. The chainsaw system as claimed in claim 8, wherein the locking unit has at least one magnet element designed, in at least one operating state, to exert a holding force upon the locking element.

11. The chainsaw system as claimed in claim 1, wherein the coupling unit has at least one positioning bolt designed to at least one of align and orient the saw blade module relative to the chainsaw.

12. The chainsaw system as claimed in claim 1, wherein the chainsaw has at least one receiving recess designed to at least partially receive the saw blade module in a mounted state.

13. A saw blade module for use in a chainsaw system that includes a chainsaw with at least one release unit and at least one coupling unit designed to couple the saw blade module to the chainsaw, the saw blade module comprising:
a cutting strand and
at least one guide unit designed for guiding at least a part of the cutting strand,
wherein the saw blade module is designed to be coupled to the chainsaw with the at least one coupling unit, and to be decoupled from the chainsaw without use of tools by the at least one release unit, which includes at least one actuating unit.

14. A chainsaw comprising:
at least one release unit that includes at least one actuating element and is designed for decoupling, without use of tools, at least one saw blade module, which is coupled to a chainsaw by a coupling unit and includes a cutting strand and at least one guide unit designed to guide at least a part of the cutting strand, from the chainsaw.
